(19) United States
(12) Patent Application Publication
(10) Pub. No.: US 2010/0072909 A1
(43) Pub. Date: Mar. 25, 2010

(54) System for Field-Programmed Determination of Illumination Set Points in Ballasts

(76) Inventors: Tony O'Gorman, Grayslake, IL (US); Dennis Stephens, Barrington, IL (US); Steven Purdy, Alpharetta, GA (US)

Correspondence Address: KOPPEL, PATRICK, HEYBL & DAWSON, 2815 Townsgate Road, SUITE 215, Westlake Village, CA, 91361-5827, US

(21) Appl. No.: 12/564,872

(22) Filed: Sep. 22, 2009

Related U.S. Application Data
(60) Provisional application No. 61/194,057, filed on Sep. 23, 2008.

(51) Int. Cl. H05B 37/02

(52) U.S. Cl. 315/246; 315/291

(57) ABSTRACT

A system for programming control of ballast illumination includes receiving a power stage input current through a first ballast input, receiving a level switch control signal at a second ballast input, entering a ballast illumination program mode, adjusting said level switch control signal to select a ballast lamp illumination and saving a field-programmed ballast lamp illumination indication in a ballast memory as representative of said ballast lamp illumination.

This application claims benefit of U.S. Provisional Application Ser. No. 61/194,057, filed Sep. 23, 2008.

### BACKGROUND OF THE INVENTION

1. Field of the Invention

This invention relates to electronic lighting ballasts, and in particular variable light level ballasts.

2. Description of the Related Art

Typically, gas discharge lamps and fluorescent lamps have a negative impedance. If this type of lamp is connected to a constant voltage power supply, the lamp current will increase beyond the rated current and the lamp or power supply will fail. To compensate for the negative impedance of the lamp, a circuit with a positive impedance greater than the negative impedance is inserted in series with the lamp. The circuit that provides this positive impedance is called an electronic ballast. In general, the 120V AC, 60 Hz mains input is rectified to DC and boosted to a higher voltage such as 400V DC. This high voltage DC rail is chopped using an inverter circuit at a frequency in the 10 kHz to 100 kHz range, referred to as high frequency. This high frequency voltage source is connected to a combination of inductors and capacitors, so that a high frequency current is supplied to the lamp. The current which flows in the lamp is controlled by changing the frequency of the inverter source, thereby controlling the ballast lamp illumination.

Previously, before electronic ballasts became practical and cost effective, a magnetic coil ballast was used to limit the current from the 120Vac, 60 Hz mains. The magnetic inductor in these ballasts provided the positive impedance to limit the current flowing through the negative impedance lamps. This magnetic coil ballast is an inefficient method of controlling the current flowing through negative impedance lamps. Consequently, electronic ballasts have replaced their magnetic counterparts in the marketplace.

When an electronic ballast is used to control the current flowing through a fluorescent lamp, it is relatively easy to modify the illumination of the light because the light output is approximately proportional to the current flowing through the lamp. The necessary circuitry to control the lamp current is already in place, but the desired light intensity needs to be communicated to the ballast. Generally, the desired illumination set point is set via a separate 0-10V dc input to the ballast which is varied directly by a user or indirectly via an automated system, such as a building energy controller. A typical dimming ballast will allow the ballast lamp illumination to be varied between 5% and 100%.

A consequence of the 0-10V input requirement is that a pair of wires generally needs to be run from the ballast, mounted in a ceiling enclosure, to a location where a person can easily set a control knob. These wires are required also in cases where the light level is set via an automatic system, such as a computer. This 0-10V wiring needs to be isolated from the main AC supply for safety reasons. This adds cost to a new installation because additional wires need to be run, but is particularly expensive when it is desired to replace standard fixed light ballasts with the dimming equivalent.

### SUMMARY OF THE INVENTION

A system of controlling ballast illumination is disclosed, for use in either step dimming or continuous dimming mode, to enable installation, selection and control of field programmed lamp illumination levels in ballast locations that do not have pre-existing 0-10V input signaling wires available for such use.

In one embodiment, a method is described for programming control of ballast illumination that includes receiving a power stage input current through a first ballast input, receiving a level switch control signal at a second ballast input, entering an illumination program mode for the ballast, adjusting the level switch control signal to select a ballast lamp illumination and saving a field-programmed ballast lamp illumination indication in a ballast memory as representative of the ballast lamp illumination.

In a further embodiment, a ballast apparatus is described that includes a lamp drive to drive a ballast lamp, when a ballast lamp is present, a ballast inverter stage to drive the lamp drive with a frequency-varying ballast inverter stage output signal and an input conditioning and isolation circuit to receive a level switch control signal and to output a pulse-width modulated (PWM) ballast control signal representative of the level switch control signal to a microcontroller. The microcontroller is configured to enter a program mode to determine a field-programmed ballast lamp illumination in response to detection of a plurality of level switch control signal transitions, save the field-programmed ballast lamp illumination in a ballast memory and to drive the ballast inverter stage with a ballast inverter stage control signal so that the ballast apparatus saves a field-programmed ballast lamp illumination for later use.

### BRIEF DESCRIPTION OF THE DRAWINGS

FIG. 1 is a block diagram illustrating one embodiment of a ballast connected to a level switch providing 0-10V DC for use in a continuous dimming mode;

FIG. 2 is a block diagram that incorporates the same ballast illustrated in FIG. 1, with the ballast connected to a level switch providing 120-277V AC for use in a step dimming mode;

FIG. 3 is a flow diagram illustrating one embodiment of a step dimming program mode used to capture a field-programmed ballast lamp illumination using the ballast connected according to FIG. 2;

FIG. 4 is a flow diagram illustrating one embodiment of the Illumination Program Mode step used in the step dimming program mode of FIG. 3;

FIG. 5 is a flow diagram illustrating one embodiment of a continuous dimming program mode used to capture field-programmed ballast lamp illuminations using the ballast connected according to FIG. 1;

FIG. 6 is a flow diagram illustrating one embodiment of the Illumination Program Mode step used in continuous dimming program mode FIG. 5;

FIGS. 7 and 8 are graphs illustrating ballast lamp illumination verses level switch control signal voltage for the continuous dimming program mode and use mode;

FIG. 9 is a flow diagram illustrating, in one embodiment, a step dimming mode to switch between a maximum illumination set point and a system minimum light illumination for the ballast connected according to FIG. 2;

FIG. 10 is a state diagram illustrating the step dimming mode described in FIG. 9;

FIG. 11 is a flow diagram illustrating, in one embodiment, a step dimming mode to provide a round-robin step dimming between a system minimum light illumination, next greater pre-determined illumination step and a maximum illumination set point for the ballast connected according to FIG. 2.

FIG. 12 is a state diagram of the round-robin step dimming illustrated in FIG. 11;

FIG. 13 is a flow diagram illustrating one embodiment of a continuous dimming mode of operation for the ballast illustrated in FIG. 1.

### DETAILED DESCRIPTION OF THE INVENTION

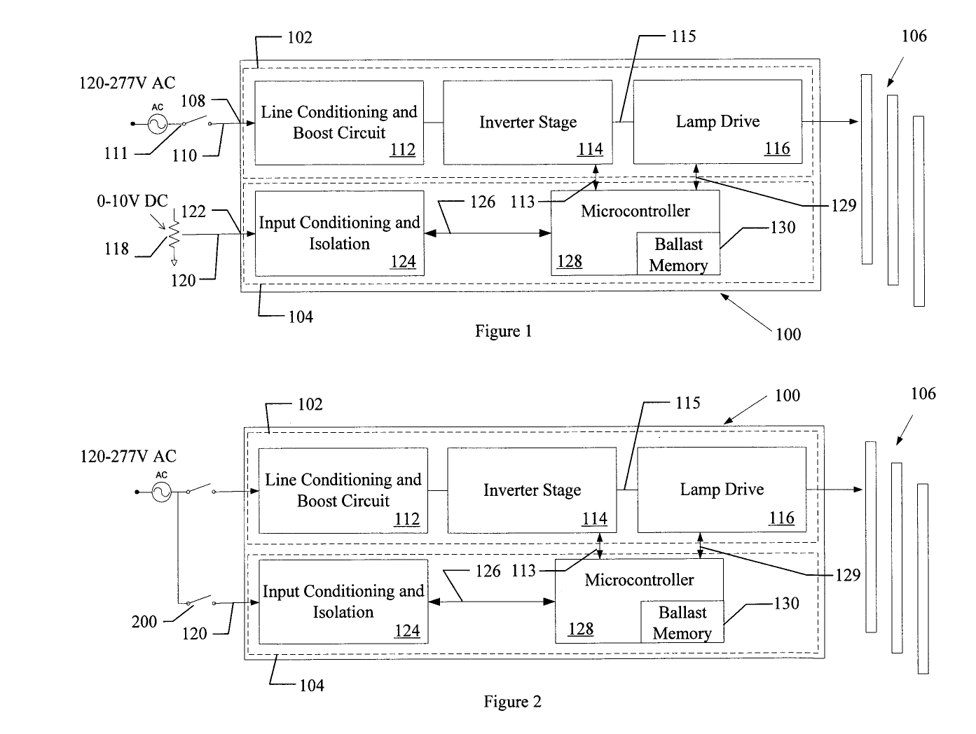

FIGS. 1 and 2 illustrate a ballast system that allows operation in both step dimming and continuous dimming modes, with the ballast system automatically detecting whether AC mains or traditional 0-10V DC are connected for ballast lamp illumination switching. Illumination levels may be dimmed between different field-programmed and pre-determined illumination levels without the need for a separate 0-10Vdc input control. For example, a user of an installed ballast lamp illumination, in one embodiment, may switch between 33%, 66% and 100% of full illumination, with at least one of such step dimming illumination levels adjustable via a particular sequence of on/off operations of either the AC mains or 0-10V DC signaling connected to the ballast system's conventional 0-10V DC input terminals.

More particularly, FIG. 1 illustrates one embodiment of a ballast 100 that has power and control stages (102, 104) configured to illuminate a ballast lamp 106 in electrical communication with the power stage 102 in a continuous dimming mode configuration. Although the following description uses the term “lamp” in a singular form of the noun for convenience, it is appreciated that the word “lamp” is intended to encompass one or more ballast lamps collectively driven by the power stage 102.

Turning first to the light ballast power stage 102, the ballast 100 has a first ballast input 108 for introduction of a ballast power signal 110 from an AC mains terminal 111 into a line conditioning and boost circuit 112 forming part of the power stage 102. The ballast power signal 110 is preferably 120-277V AC at 60 Hz as representative of typical AC mains voltages found in the United States. However, in an alternative embodiment, the ballast power signal 110 may be adapted to region of interest or to a particular application, such as 220V AC at 50 Hz, such as found in the People's Republic of China (mainland only). The line conditioning and boost circuit 112 is preferably a critical transition boost circuit and power factor controller in electrical communication with an inverter stage 114. The inverter stage 114 is preferably a series resonant, parallel loaded circuit that drives a lamp drive 116 by driving a half bridge resonant circuit (not shown). The line conditioning and boost circuit 112, inverter stage 114 and lamp drive 116 define the power stage 102 and are well known by those of ordinary skill in the art of electronic ballasts.

Turning next to the control stage 104, a level switch 118, illustrated in FIG. 1 as a variable potentiometer, outputs a 0-10V DC level switch control signal 120 to a second ballast input 122 for presentation of the level switch control signal 120 to an input conditioning and isolation circuit 124. The input conditioning and isolation circuit converts the level switch control signal to a ballast control signal representative of the level switch control signal, preferably a pulse-width modulated (PWM) control signal 126, for communication to a microcontroller 128 that samples the PWM ballast control signal, with control stage 104 defined as including the microcontroller 128 and input conditioning and isolation circuit 124. The microcontroller 128 drives the inverter stage 114 with a ballast inverter stage control signal 113 in response to receipt of the PWM control signal 126, with the inverter stage 114 providing the lamp drive 116 with a frequency modulated lamp power signal 115 to drive the lamp 106 to a desired illumination. The lamp drive 116 receives a lamp drive feedback voltage signal 129 from the microcontroller 128 that is representative of the desired lamp current so that the lamp drive may compare the actual lamp current with the desired lamp current to complete a feedback loop between the microcontroller 128, inverter stage 114 and lamp drive 116 for controlled illumination of the ballast lamp 106, as is well known by those of ordinary skill in the art of electronic ballasts.

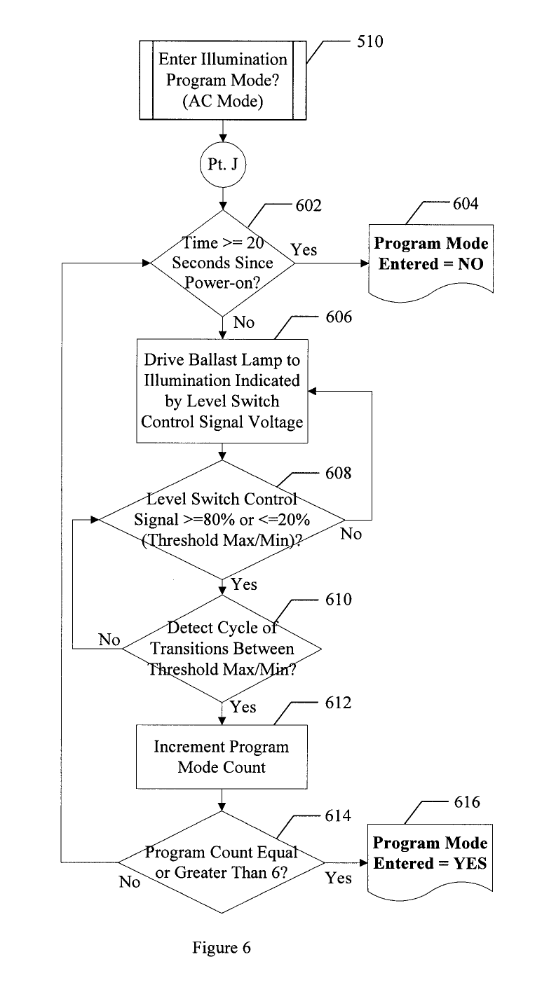

In a preferred embodiment, the microcontroller 128 is automatically configured to enable selection and storage of field-programmed maximum and minimum illumination set point indications in the ballast memory 130 for subsequent use in response to receipt of a predetermined plurality of level switch control signal transitions between a threshold system-high DC voltage and threshold system-low DC voltage (See FIGS. 5 and 6). The microcontroller 128 is also configured to store AC/DC mode indications in the ballast memory 130 to enable appropriate operation of the ballast 100 upon initial or subsequent ballast 100 installations. Although illustrated as sitting in the microcontroller 128, the ballast memory 130, preferably FLASH electronically erasable memory, may be controller memory or memory located off chip for receipt of the field-programmed ballast illumination indication(s) and AC/DC mode indication.

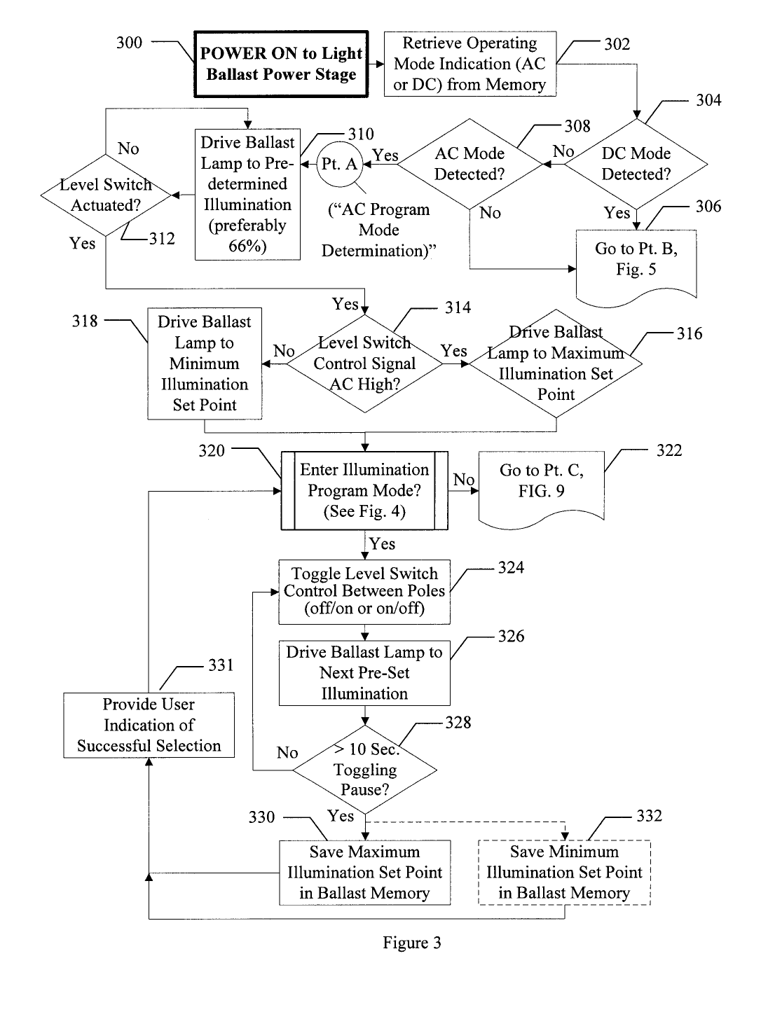

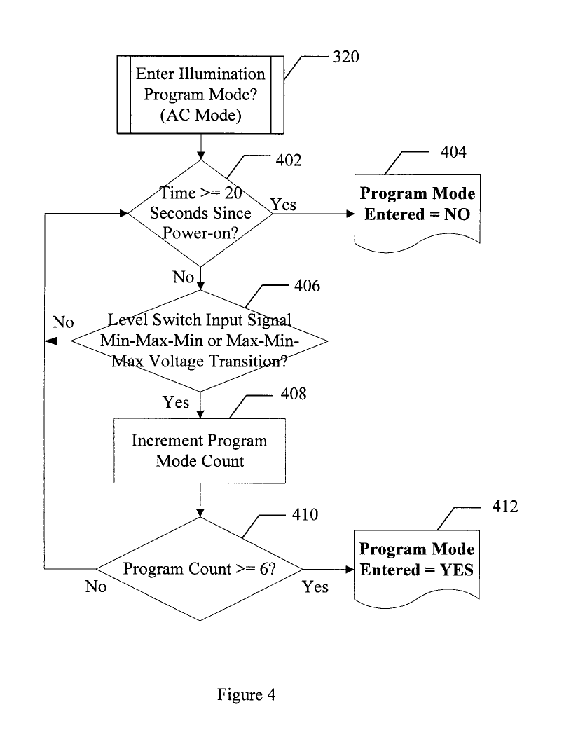

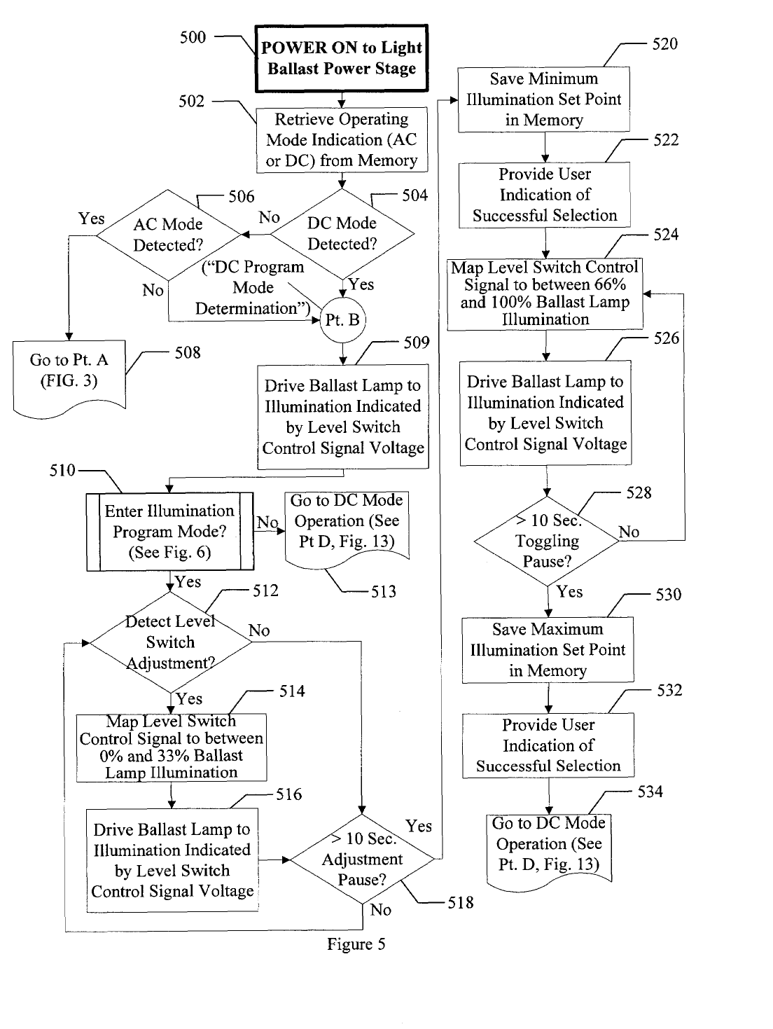

FIG. 2 illustrates use of the ballast 100 illustrated in FIG. 1 and installed for use with a level switch 200 that is a single pull, single throw switch to provide switching between AC mains voltage (preferably 120-277V AC at 60 Hz) and the input conditioning and isolation circuit 124 for use in a step dimming mode. In one embodiment of this installation configuration, the microcontroller 128 is automatically configured to enable acceptance and storage of a field-programmed maximum illumination set point indication in the ballast memory 130 for subsequent use in response to receipt of a predetermined plurality of level switch control signal transitions between either min-max-min or max-min-max AC mains voltage (See FIGS. 3 and 4). As in the ballast configuration illustrated in FIG. 1, the microcontroller 128 is also configured to store AC/DC mode indications in ballast memory 130 to enable appropriate operation of the ballast 100 upon initial or subsequent ballast 100 installations.

In one implementation of a power stage 102 designed for use with a ballast power signal 110 of 120-277V AC, the line conditioning and boost circuit is a power factor controller IC Model No. MC33262 (offered by Motorola, Inc.) that outputs an 80-175 W ballast power signal to inverter stage 114 that is an inverter IC Model No. L6574 (offered by STMicroelectronics, Inc. headquartered in Geneva, Switzerland). The power factor controller IC may be substituted with other commercially-available equivalents. The lamp drive 116 is preferably a series resonant parallel loaded circuit (not shown), as is known in the art, with the output frequency varied to control ballast lamp 106 illumination while controlling shoot through current.

In one implementation of a control stage 104 for use with the described power stage 102, the level switch control signal 120 (preferably 0-10V DC or 120-277V AC) is communicated to the input conditioning and isolation circuit 124 that is a pulse-width modulation control circuit Model No. TL494 (offered by Texas Instruments Incorporated of Dallas, Tex.) or other functional equivalent. The input conditioning and isolation circuit 124 translates the level switch control signal 120 to a 5 V pulse train for communication to microcontroller 128 after low pass filtering and electrical isolation through an opto-isolator (not shown). The microcontroller is preferably an 8-bit 18 Pin Processor Model No. 16F88 (offered by MicroChip Technology, Inc. of Chandler, Ariz.), or may be another equivalent microcontroller or microprocessor with on-board or off-chip memory. In the embodiment described, above, the ballast lamp 106 is composed of T8 fluorescent lamps in either a two or three lamp configuration.

FIG. 3 illustrates one embodiment of a method to select and save to ballast memory field-programmed ballast lamp illumination indications, preferably at least a maximum illumination set point, for the ballast 100 installed in the step dimming mode configuration illustrated in FIG. 2. Power is provided or otherwise switched to the ballast power stage (300) and the microcontroller attempts to retrieve a previously-saved operating mode indication from memory (302). If a continuous dimming mode (alternatively called ‘DC Mode’) is detected (304), preferably from retrieval of the operating mode indication from ballast memory or through independent detection of the mode by microcontroller analysis of the PWM control signal, the microprocessor automatically switches to continuous dimming mode and preferably begins DC program mode determination (306) (see Pt. B, FIG. 5). If continuous dimming mode is not detected (304) but step dimming mode is detected (308), the ballast lamp is driven to a pre-determined illumination (306), preferably 66% illumination or such other value as determined by the designer of the ballast. If ‘step dimming’ mode is not detected (304) but DC mode is detected (308) then the microprocessor switches to DC mode (alternatively call ‘continuous dimming’ mode) for startup (310). Otherwise, the microcontroller defaults to DC mode (308) and preferably begins DC program mode determination (306) (see Pt. B, FIG. 5). The microcontroller monitors the PWM control signal to determine if the level switch is actuated (312) and, if an AC-high condition of the level switch control signal is detected (314), the ballast lamp is preferably driven to a maximum illumination set point (316). Or, if a maximum illumination set point is not available (such upon initial ballast installation), the ballast lamp may be driven to a pre-determined maximum system illumination (defined as 100% illumination). If an AC-high condition is not detected (314), then the ballast lamp is driven to a minimum illumination set point (318). Or, if a minimum illumination set point is not available, the ballast lamp may be driven to a pre-determined minimum system illumination (for example, 33% illumination) and the microcontroller begins to monitor the PWM control signal to determine whether or not to enter illumination program mode (320) (See FIG. 4) based on user actuation of the level switch 200 (See FIG. 2).

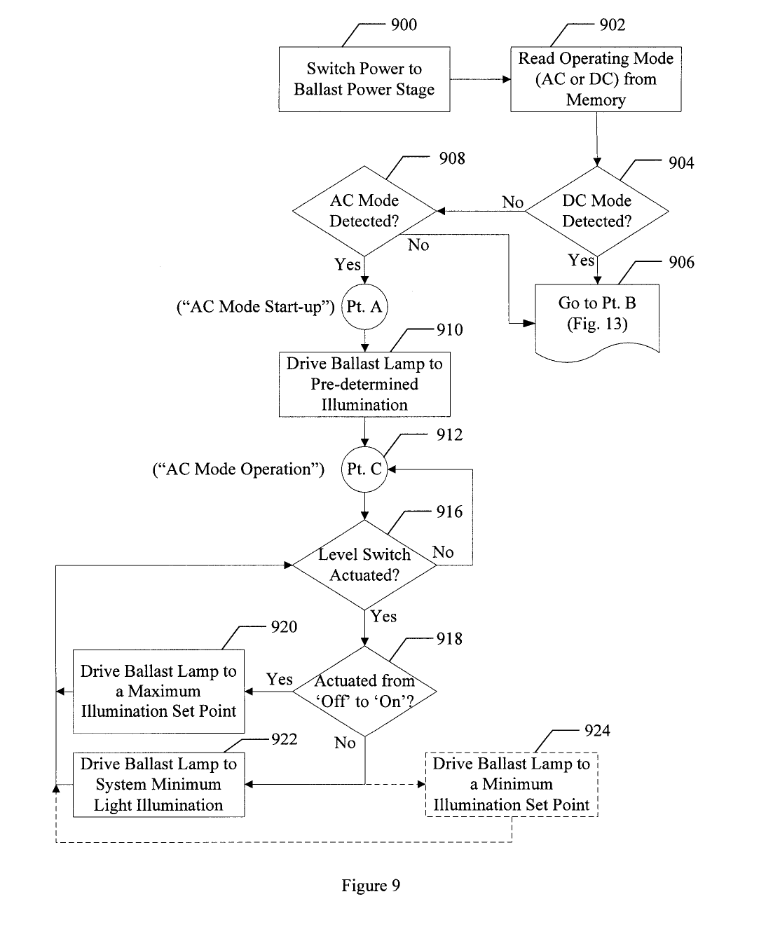

If the microcontroller determines program mode is not entered, then the ballast 100 is configured for step dimming mode (322) (See Pt. C, FIG. 9). If illumination program mode is entered (320) (See FIG. 4), then the level switch is toggled (if a mechanical switch) such as from ‘Off’ to ‘On’ or from ‘On’ to ‘Off’ (324) step the ballast illumination by driving the ballast lamp to the next preset illumination (326), such as the predetermined illumination plus 15%. If the microcontroller detects a toggling pause of greater than 10 seconds (328) then a maximum illumination set point is saved in ballast memory (330) corresponding to the existing ballast lamp illumination and the user is provided with an indication of successful selection (331), such as by flashing the ballast lamp 106 to 100% illumination and back to 5% illumination for a certain time each such as 0.5 seconds each. The microcontroller then returns to determine if illumination program mode is still active (320) (See FIG. 4). In an alternative embodiment, rather than a maximum illumination set point determination (330), a minimum illumination set point is saved in memory (332) or, interim illumination set points may be determined and saved in memory (not shown). In this manner, a user may field program a maximum illumination set point for storage in memory for later use in a stepped dimming mode. Although illumination is described throughout this specification in terms of percentage illumination, it is to be understood that such a percentage is relative to a system maximum light illumination corresponding to a permissible maximum illumination set point for the ballast.

FIG. 4 illustrates one embodiment of an illumination program mode determination for use in step 320 of the step-dimming program mode illustrated in FIG. 3. As used in FIG. 3, this example embodiment is used to determine if a user intends to enter field-programmed illumination set points, such as maximum or minimum illumination set points, while the ballast is installed for use in step dimming mode. The microcontroller determines if a program mode time out period has been exceeded, preferably twenty seconds or longer from switching of power to the ballast power stage (402) (See step 300, FIG. 3) (alternatively referred to as ballast “power on”) and, if the timeout period has been exceeded, returns a Program Mode Entered=‘NO’ (404) result to time out of step dimming program mode. The microcontroller then continues to step dimming operation (See step 322, FIG. 3). Otherwise, if the timeout period has not been exceeded, the microcontroller monitors the PWM control signal 126 for further indication of transitions between threshold minimum and threshold maximum level switch control signal values, preferably an ‘on-off-on’ or ‘off-on-off’ AC mains voltage transition (406) (alternatively referred to as max-min-max and min-max-min voltage transitions, respectively) made since the last program mode count. If such a transition is detected, a program mode count in the microprocessor is incremented (408) and compared to a maximum program count (410), preferably six ‘on-off-on’ and/or ‘off-on-off’ switch transitions. If the incremented program mode count is equal to or greater than six cycles, the microcontroller returns a Program Mode Entered=‘YES’ indication (412) (or its equivalent) and the controller returns to the step dimming program mode (See step 320, FIG. 3) for determination of a new maximum illumination set point. If the incremented program mode count is less than the maximum program count (410), the microcontroller returns to determine if twenty or more seconds have elapsed since switching power on to the ballast power stage (See step 300, FIG. 3) (402) to determine if the step dimming program mode has timed out. If the program mode is still active and the microcontroller detects a level control signal voltage transition (either an ‘on-off-on’ or ‘off-on-off’) (406), then the program mode count is again incremented (408) and compared to the maximum program count (410) to determine if illumination program mode is entered to enable selection and saving to ballast memory of a maximum illumination set point.

Although the incremented program mode count is compared to a maximum program count of six in the illustrated embodiment, the program count may be less than or greater than six to accomplish the goals of the ballast 100 programmer. In an alternative embodiment, both the accumulated program mode count and the pace of such control signal transitions may be monitored to determine whether or not to enter illumination program mode (See step 320, FIG. 3). Or, if a single pull, single throw level switch is replaced by a programmed switch, electrical switch, or other switching device, the microcontroller 128 may monitor the level switch control signal 126 for suitable changes that indicate switch transitions signaling the start of illumination program mode within the chosen system timeout period.

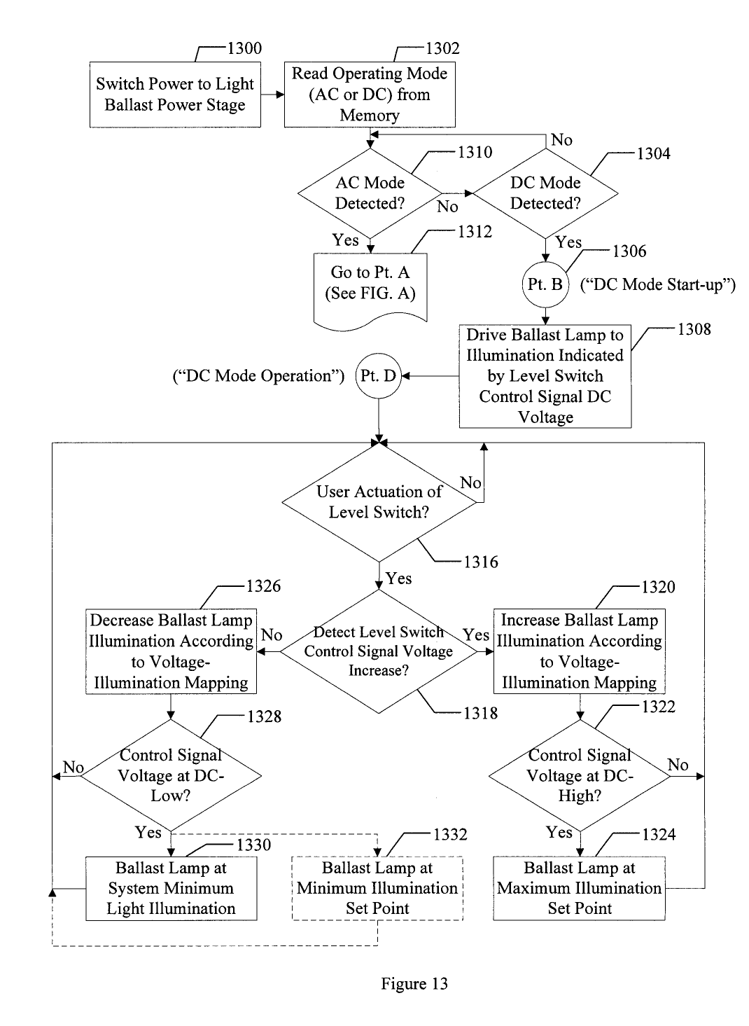

FIG. 5 illustrates a flow diagram of one embodiment of a continuous dimming program mode to select and save to ballast memory field-programmed ballast lamp illumination indications, such as a maximum illumination set point and minimum illumination set point. Power is switched to the light ballast power stage (500) and the operating mode indication is read from ballast memory (502), if available. If DC mode not detected (504), either through retrieval of the operating mode indication from ballast memory or through independent detection of the mode by microcontroller analysis of the PWM control signal, the controller determines if AC mode is detected (506). If so, the controller switches to AC mode for AC Program Mode Determination (508). Otherwise, if the microcontroller detects DC mode (504) or if AC mode is not detected (506), the controller remains in DC mode and enters DC Program Mode Determination (Pt. B) The ballast lamp is driven to an illumination indicated by the voltage of the level switch control switch (509) and the microcontroller determines if illumination program mode is to be entered (510) (See FIG. 6). If the controller determines that illumination program mode is entered (510), then the microcontroller monitors the PWM control signal 126 for indication of a level switch adjustment (512). Otherwise, the controller automatically enters DC mode operation (513) (See Pt. D, FIG. 13) If a level switch adjustment is detected (512), the microcontroller maps the level switch control signal to a minimum illumination set point selection range, preferably between a 0% and 33% ballast illumination (514) and the ballast lamp is driven to the indicated illumination (516). If the microcontroller detects a pre-determined pause length in adjustment of the level switch (alternatively referred to as a “toggling pause”), preferably greater than 10 seconds between level switch adjustments, or if no level switch adjustment is detected for preferably greater than 10 seconds (518) then the ballast lamp illumination is saved in ballast memory as a minimum illumination set point (520) and the user is provided with an indication of successful selection (522) such as by flashing of the ballast lamp to 100% illumination and back to 5% illumination for 0.5 seconds each. The microcontroller then maps the switch control signal to a maximum illumination set point selection range, preferably between 66% and 100% ballast illumination (524), and drives the ballast lamp to the illumination indicated by the level switch control signal voltage (526). If the microcontroller detects a pause in adjustment of the level switch, preferably greater than 10 seconds between level switch adjustments (528) then the indicated illumination is saved as a maximum illumination set point in ballast memory (530) and the user is again provided with an indication of successful selection (532) such as by way of flashing of the ballast lamp 106 to 100% illumination and back to 5% illumination and the microcontroller returns operation to DC mode operation (534) (See FIG. 13).

In alternative embodiments, the minimum illumination set point range of between 0% and 33% (See step 514) may consist of a different range such as 5% to 25%. Similarly, the maximum illumination set point values presented to the user may be different than between 66% and 100% illumination, such as 75% to 95% or other range programmed by ballast designer. Also, although the microcontroller is programmed to monitor the PWM control signal for level switch adjustment pauses extending greater than 10 seconds, other adjustment pause values may be used, such as greater than 5 seconds or greater than 15 seconds in order to accomplish the goals of the ballast designer. In other embodiments, the user indication of successful selection of either a minimum or maximum illumination set point indication may be provided by other means besides ballast lamp flashing, such as other ballast lamp illumination flash patterns intensities or display indication on the level switch itself such as by an indicator light.

FIG. 6 illustrates one embodiment of the Illumination Program Mode step 510 used by the continuous dimming program mode illustrated in FIG. 5. This example embodiment is used to determine if a user intends to enter field-programmed illumination set points (such as maximum or minimum illumination set points) for use in a continuous dimming mode. The microcontroller determines if 20 seconds or longer has elapsed from switching of power to the ballast power stage (602) (See Step 500, FIG. 5) and, if 20 seconds or longer has elapsed, indicates a Program Mode Entered=‘NO’ (604) result and times out of continuous dimming program mode to enter continuous dimming operation (See Step 511, FIG. 5). Otherwise, if less than 20 seconds have elapsed, the ballast lamp is driven to the illumination indicated by the level switch control signal voltage (606) and the microcontroller continues monitor the PWM ballast control signal for a predetermined pattern of level switch control signals. For example, a threshold system-high DC voltage (“threshold maximum”) transition to a threshold system-low DC voltage (“threshold minimum”) (preferably greater than or equal to 80% of level switch control signal DC high or less than or equal to 20% of level switch control signal DC high, respectively) (608) and then back to the threshold maximum voltage may be the predetermine pattern. In this embodiment, if the microcontroller detects transitions of the level switch control signal between threshold maximum and threshold minimum and back to threshold maximum (610) (or from threshold minimum to threshold maximum and back to threshold minimum) a program mode count in the microprocessor is incremented (612) to count cycles and compared to a maximum program count (614), preferably six threshold to threshold to threshold cycles. Preferably, if the incremented program mode count is equal to or greater than six cycles, the microcontroller returns a Program Mode Entered=‘Yes’ indication (616) (or its equivalent) then the controller returns to the continuous dimming program mode (See FIG. 5) for determination of a new minimum illumination set point and maximum illumination set point. If the incremented program count is less than the maximum program count (614), the microcontroller returns to determine if 20 or more seconds have elapsed since switching power ‘on’ to the ballast power stage (602) (See Step 500, FIG. 5). The ballast lamp is maintained at an illumination indicated by the level switch control signal voltage (606) and the microcontroller returns to determine if the level switch control signal is above a threshold maximum or below a threshold minimum (608). If so, the microprocessor determines if a cycle of transitions has occurred between the threshold maximum and the threshold minimum values (610). If a cycle of transition is detected, then the program mode count is again incremented (612) and compared to the maximum program count (614) to determine if a Program Mode Entered=‘Yes’ indication 616 should be returned so that the controller returns to the continuous dimming program mode (See step 510, FIG. 5).

As provided in one embodiment of the step dimming mode programming illustrated above, although the incremented program mode count is compared to a maximum program count of six in the illustrated embodiment, the program count may be less than or greater than six to accomplish the goals of the ballast 100 programmer. Preferably, only the accumulated program mode count is compared to a maximum program count, however, other schemes may be utilized to enable program mode including as described above for the step dimming program mode.

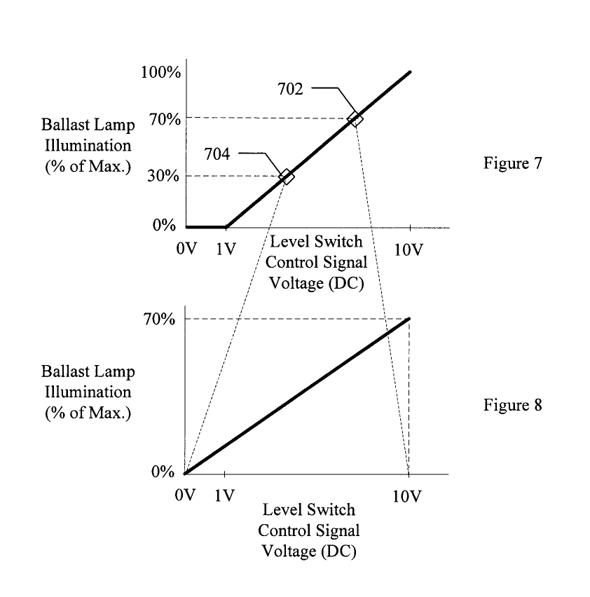

FIG. 7 is a graph illustrating ballast lamp illumination output versus level switch control voltage provided to the input conditioning and isolation circuit illustrated in FIG. 1. As is known in the art for factory-configured ballasts for use in continuous dimming mode operation, a level switch control voltage of zero to approximately 1V DC may result in a ballast lamp illumination of zero. As the level switch control voltage presented to the input conditioning and isolation circuit increases linearly from 1V DC to the maximum allowable DC input of 10V DC, the ballast lamp illumination is typically increased linearly from 0-100% illumination. For the embodiments illustrated in FIGS. 5 and 6, a field-programmed ballast lamp illumination may be programmed for later user retrieval in the form of a maximum illumination set point 702 (for example, 70% illumination) and a minimum illumination set point 704 (for example, 30% illumination). Although illustrated as representing 70% illumination and 30% illumination, respectively, the maximum and minimum illumination set points are preferably programmed between 0-33% and 66-100% illumination, respectively. Or, the set of available illumination percentage ranges for each of the maximum and minimum illumination set points may be chosen for the convenience of the ballast programmer to accomplish field programmability for the ballast lamp illumination. During the steps illustrated in FIG. 5, the microcontroller maps the level switch control signal inputs of 0V DC to the minimum illumination set point 704 and 10V DC control input value to the maximum illumination set point 702 with the resultant interim illumination values generally provided linearly between the minimum and maximum illumination set points.

In an alternative embodiment, ballast lamp illumination values between minimum and maximum illumination set points may be non-linear, such as stepped, logarithmic, or other illumination versus control signal voltage input curves that accomplishes the goals of the ballast programmer.

FIG. 9 is a block diagram illustrating one embodiment of a stepped use mode for ballast 100. Power is switched to the ballast power stage (900) and the operating mode is read from memory (902). If DC mode is detected (904), the microcontroller automatically proceeds to DC mode startup (906) (See Pt. B, FIG. 13). If AC mode is detected (908) then the microcontroller 100 continues to AC mode startup (Pt. A). Otherwise, the microcontroller defaults to DC mode and proceeds to DC mode startup (908, 906) (See Pt. B, FIG. 13). If proceeding to AC mode startup (Pt. A) the ballast lamp is driven to a predetermined illumination (910), preferably 66% illumination, and AC mode operation begins (912). If the microcontroller 128 receives a PWM control signal 126 indicating actuation of the level switch (916), and such indication indicates a switching from ‘off’ to ‘on’ (918) (preferably transitioning a level switch control signal from a zero voltage signal to an AC voltage signal), then the ballast lamp is driven to the previously determined maximum illumination set point (920) and the microcontroller continues to monitor for subsequent level switch actuation (916). If the microcontroller receives a PWM control signal 126 indicating a level switch actuation (916) but does not determine such actuation to be ‘off’ to ‘on’ (preferably transitioning a level switch control signal from an AC voltage signal to zero voltage signal actuation), then the ballast lamp is driven to a previously determined system minimum light illumination, preferably 33% illumination, (922) and the microcontroller again monitors for subsequent level switch actuation (916).

In an alternative embodiment, if a minimum illumination set point is available in the microcontroller, the ballast lamp is driven to a minimum illumination set point if such level switch actuation is not determined to be ‘off’ to ‘on’ actuation (918, 924). Although the embodiment illustrated in FIG. 9 describes detection of an ‘off’ to ‘on’ level switch actuation, in one embodiment the microcontroller monitors for an ‘on’ to ‘off’ actuation to drive the ballast lamp to a system minimum light illumination with the alternative case defaulted to drive ballast lamp to a maximum illumination set point (See Steps 918, 920, 922). Similarly, although the preferred embodiment teaches a predetermined illumination of 66%, other illumination levels may be chosen by the designer of the ballast 100, such as 58% or 75% illumination value.

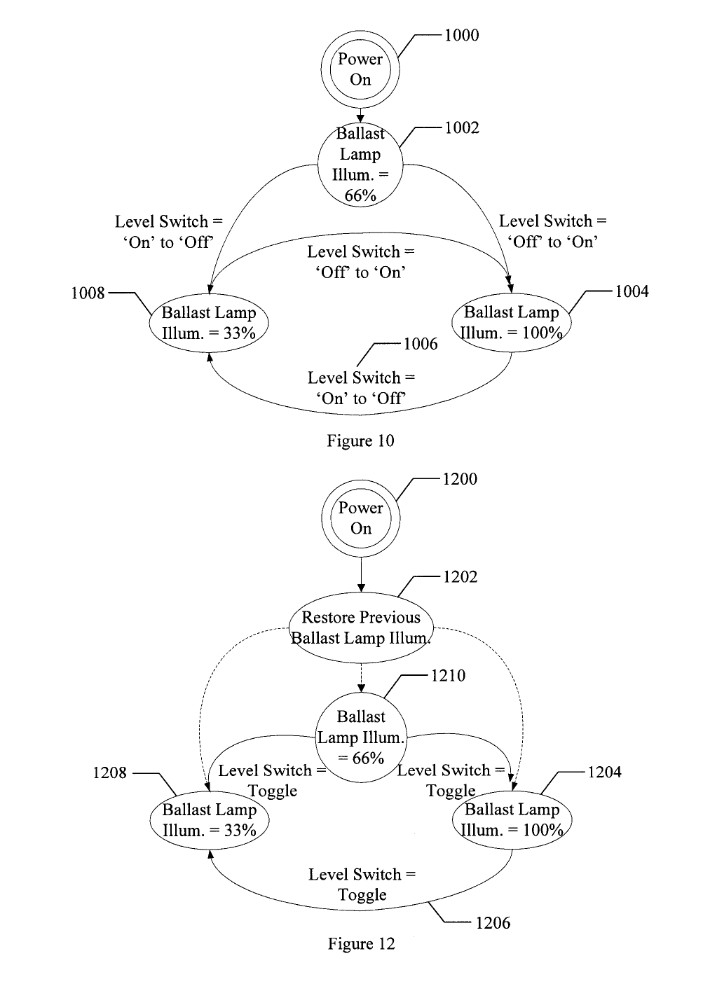

FIG. 10 illustrates a state diagram for the stepped-use mode described in FIG. 9. Upon power ‘on’ of ballast, preferably in response to application of power to the ballast power stage (1000), the ballast lamp is driven to a predetermined illumination of 66% (1002) that is manufacturer-fixed ballast lamp illumination. If the level switch transitions from an ‘off’ to ‘on’ position, the ballast lamp is driven from the 66% predetermined ballast lamp illumination to a field-programmed ballast lamp illumination, preferably an illumination that is a maximum illumination set point having a value of 100% in the absence of field programming (1004). Actuation of level switch from ‘on’ to ‘off’ (1006) results in the ballast lamp being driven from the first field-programmed ballast lamp illumination to a second field-programmed ballast lamp illumination, preferably an illumination that is a minimum illumination set point having a value of 33% illumination in the absence of field programming (1008). Upon actuation of the level switch from ‘off’ to ‘on’, the ballast lamp is driven from the second field-programmed ballast lamp illumination back to the first field-programmed ballast lamp illumination to provide for continued toggling of ballast lamp illumination from 100% to 33% to 100% illumination, as illustrated in this embodiment.

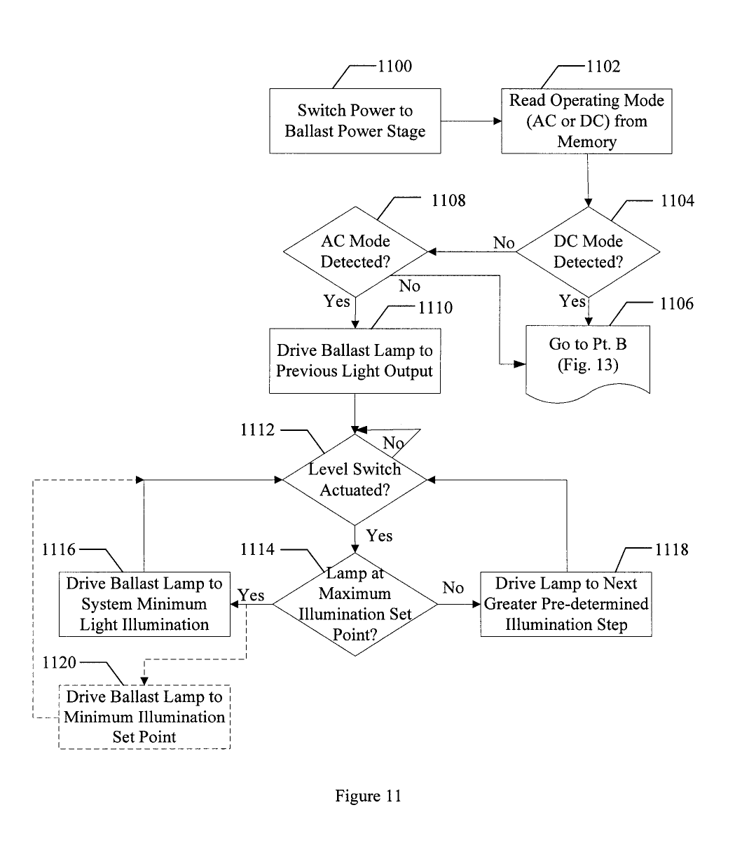

Although the ballast 100 may be configured to provide for step-dimming that toggles between two field-programmed levels, FIG. 11 illustrates one embodiment that allows for a round-robin toggling between a plurality of illumination levels. Power is switched to the light ballast power stage (1100) and the operating mode is retrieved from ballast memory (1102). If DC mode is detected (1104), the microcontroller automatically proceeds to DC mode startup (1106) (See Pt. B, FIG. 13). If AC mode is detected (1108) then the microcontroller continues to AC mode startup. Otherwise, the microcontroller defaults to DC mode and proceeds to DC mode startup (1108, 1106) (See Pt. B, FIG. 13). If proceeding to AC mode startup, the ballast lamp is driven to a previous light output retrieved from memory (1110) and the microcontroller monitors the PWM control signal 126 for indication of a level switch actuation (1112). If a level switch actuation is indicated (1112), the microcontroller determines if the ballast lamp is at a maximum illumination set point (1114). If so, the ballast lamp is driven to a system minimum light illumination, preferably 33% illumination, (1116) in response to the level switch activation and the microcontroller returns to monitor the PWM control signal for further level switch actuation (1112). Otherwise, the ballast lamp is driven to a next greater predetermined illumination step (1118). For example, if the ballast lamp illumination is 33%, the next greater predetermined illumination step is preferably 66%, or if the ballast lamp illumination is 66%, the next greater predetermined illumination step in preferably 100%. In an alternative embodiment, if a minimum illumination set point is available to the microcontroller, such a value would be used in place of the system minimum light illumination (1116, 1120) for purposes of the round-robin alteration described in the embodiment illustrated in FIG. 11.

FIG. 12 illustrates a state diagram for the stepped use mode described in FIG. 11. Upon power ‘on’ of the ballast power stage (1200), a previous ballast lamp illumination is retrieved from ballast memory (1202) and the ballast lamp is driven to the retrieved illumination. Similar to the embodiment illustrated in FIG. 10, the ballast lamp illumination is configured to step in a round-robin fashion between a first field-programmed ballast lamp illumination and a system minimum light illumination. For example, in one embodiment illustrated in FIG. 12, if the microcontroller retrieves a previous ballast lamp illumination that is a maximum illumination set point of 100% illumination, the ballast lamp would be illuminated to 100% (1204). Upon a further toggle of the level switch (1206), the ballast lamp is driven to a system minimum light illumination, preferably 33% illumination (1208). Further actuation (i.e., a toggle) would result in the microcontroller driving the ballast lamp to the predetermined illumination, preferably 66% (1210). A further actuation of the level switch would result in the ballast lamp being driven to the maximum illumination set point of 100%. In an alternative embodiment, the system minimum light illumination may be replaced with a field-programmed ballast lamp illumination that is a minimum illumination set point. Or, if interim values of ballast lamp illumination are also field programmable, such values may be used by the controller to drive the ballast lamp to intermediate values in the round-robin configuration illustrated in FIG. 12.

FIG. 13 illustrates one embodiment of a continuous-dimming mode (DC mode) that uses a level switch 200 that is a potentiometer to provide the input conditioning and isolation circuit with a level switch control signal that is approximately 0-10 V DC for proportional illumination control of the ballast lamp. Power is provided to the light ballast power stage (1300) and the operating mode is determined either through retrieved from ballast memory (1302) or from microcontroller detection of the PWM control signal. If DC mode is detected (1304), the microcontroller proceeds to DC mode startup (1306) and the ballast lamp is driven to the illumination indicated by the level switch control signal DC voltage (1308). Otherwise if AC mode is detected (1310), the microcontroller proceeds to AC mode startup (1312) (See FIG. 9). Subsequent to the ballast lamp being driven to the illumination indicated by the level switch control signal, the microcontroller enters DC mode operation (1314) and the microcontroller monitors the PWM control signal 126 for indication of level switch actuation (1316). If the microcontroller detects an increase in the level switch control signal voltage (1318), the microcontroller drives the ballast lamp illumination according to previously determined voltage illumination mapping (1320) available to the microcontroller such that a control signal voltage at DC high results in a ballast lamp illumination at the maximum illumination set point (block 1322, 1324) and the microcontroller monitors for further actuation of the level switch (1316). The maximum illumination set point is preferably factory programmed to default to a system maximum illumination in the absence of field programming, and is defined as the maximum ballast illumination available to a user through microcontroller control of the power stage 102 (regardless of ballast mode). Similarly, if the level switch control signal voltage is not increased (1315), the microcontroller decreases the ballast lamp illumination (1326) in according to the voltage-illumination mapping so that the ballast lamp arrives at a system minimum light illumination at a control signal voltage of DC-low (1328, 1330) (assuming full actuation to DC low). In an alternative embodiment, the system minimum light illumination may be by a field programmed ballast lamp illumination that is preferably a minimum illumination set point (1332).

While various implementations of the application have been described, it will be apparent to those of ordinary skill in the art that many more embodiments and implementations are possible that are within the scope of this invention.

We claim:

1. A method for programming control of ballast illumination, comprising:
receiving a power stage input current through a first ballast input;
receiving a level switch control signal at a second ballast input;
entering an illumination program mode for said ballast;
adjusting said level switch control signal to select a ballast lamp illumination; and
saving a field-programmed ballast lamp illumination indication in a ballast memory as representative of said ballast lamp illumination.

2. The method according to claim 1, wherein said field-programmed ballast lamp illumination indication represents a maximum illumination set point for at least one ballast lamp.

3. The method according to claim 1, wherein said field-programmed ballast lamp illumination indication represents a minimum illumination set point for at least one ballast lamp.

4. The method according to claim 1, further comprising:
alternating said level switch control signal between a threshold minimum level switch control signal value and threshold maximum level switch control signal value for a plurality of predetermined patterns to activate said entering an illumination program mode.

5. The method according to claim 4, wherein said alternating said level switch control signal between said threshold minimum level switch control signal value and said threshold maximum signal level switch signal value for a plurality of predetermined patterns comprises transitioning between an AC mains voltage and zero voltage and back to an AC mains voltage a plurality of cycles.

6. The method according to claim 4, wherein said alternating said level switch control signal between said threshold minimum level switch control signal value and said threshold maximum signal level switch signal value comprises transitioning between a threshold system-high DC voltage and a threshold system-low DC voltage and back to a threshold system-high DC voltage a plurality of cycles.

7. The method according to claim 1, further comprising:
retrieving from memory an operating mode indication to retrieve one of an AC mode or DC mode indication.

8. The method according to claim 1, further comprising:
providing user indication of a successful saving of said field-programmed ballast lamp illumination in said ballast memory.

9. The method according to claim 8, wherein said providing user indication comprises flashing said at least one ballast lamp.

10. The method according to claim 1, wherein said adjusting said level switch control signal comprises toggling a level switch control to step the ballast lamp illumination to a next preset illumination.

11. A ballast apparatus, comprising:
a lamp drive to drive a ballast lamp, when a ballast lamp is present;
a ballast inverter stage to drive said lamp drive with a frequency-varying ballast inverter stage output signal; and
an input conditioning and isolation circuit to receive a level switch control signal and to output a pulse-width modulated (PWM) ballast control signal representative of said level switch control signal to a microcontroller, said microcontroller configured to:
i) enter a program mode to determine a field-programmed ballast lamp illumination in response to detection of a plurality of level switch control signal transitions;
ii) save said field-programmed ballast lamp illumination in a ballast memory; and
iii) drive said ballast inverter stage with a ballast inverter stage control signal;
wherein said ballast apparatus saves a field-programmed ballast lamp illumination for later use.

12. The apparatus of claim 11, wherein said microcontroller is further configured to determine whether said level switch control signal represents an AC level switch control signal or a DC level switch control signal.

13. The apparatus of claim 12, wherein said microcontroller is further configured to switch to DC mode from AC mode or to AC mode from DC mode in response to said determination whether said level switch control signal represents said AC level switch control signal or said DC level switch control signal.

14. The apparatus of claim 11, wherein said microcontroller is further configured to detect a pre-determined pause in level switch control signal transitions after entering said program mode to initiate saving said field-programmed ballast lamp illumination in ballast memory.

15. The apparatus of claim 14, wherein said field-programmed ballast lamp illumination is a maximum illumination set point.

16. The apparatus of claim 11, wherein said microcontroller is further programmed to step ballast lamp illumination to a next preset illumination in response to detection of a level switch control signal toggling.

17. The apparatus of claim 11, wherein said microcontroller is further configured to time out from said program mode after a predetermined time-out period measured from ballast apparatus power on.

18. A method for programming ballast illumination set points for an installed ballast assembly, comprising:
transitioning a level switch control signal received by an installed ballast assembly a plurality of predetermined transition patterns to enter a program mode for determination of a maximum illumination set point;
adjusting said level switch control signal provided to said ballast assembly to select said maximum illumination set point; and
saving said maximum illumination set point in a ballast memory.

19. The method of claim 18, further comprising:
adjusting said level switch control signal to select a minimum illumination set point;
saving said minimum illumination set point in said ballast memory.

20. The method of claim 19, further comprising:
flashing a ballast lamp to provide a user with indication of a successful set point selection.

21. The method of claim 18, further comprising:
exiting program mode after a predetermined time out period.

22. The method of claim 18, wherein said saving said maximum illumination set point further comprises:
detecting a toggling pause in said adjusting said level switch control signal to trigger said saving said maximum illumination set point in ballast memory.

23. The method of claim 18, further comprising:
mapping said level switch control signal to a maximum illumination set point selection range to drive a ballast lamp to the ballast illumination indicated by said level switch control signal.

24. The method of claim 18, wherein said adjusting said level switch control signal further comprises:
toggling a level switch to switch between AC mains voltage and zero voltage to drive a ballast lamp to a next preset illumination to select said maximum illumination set point.

25. The method of claim 18, wherein said adjusting said level switch control signal further comprises:
adjusting a variable potentiometer to provide said level switch control signal to the installed ballast assembly.
